(19) United States
(12) Patent Application Publication
(10) Pub. No.: US 2016/0207357 A1
(43) Pub. Date: Jul. 21, 2016

(54) TIRE INCLUDING A REINFORCEMENT FOR REINFORCING A SIDEWALL

(71) Applicants: COMPAGNIE GENERALE DES ETABLISSEMENTS MICHELIN, Clermont-Ferrand (FR); MICHELIN RECHERCHE ET TECHNIQUE S.A., Granges-paccot (CH)

(72) Inventor: GUILLAUME ANDRE, Clermont-Ferrand (FR)

(21) Appl. No.: 15/023,185

(22) PCT Filed: Sep. 15, 2014
(86) PCT No.: PCT/EP2014/069606

§ 371 Date: Mar. 18, 2016

(30) Foreign Application Priority Data
Sep. 18, 2013 (FR) 1358960

(51) Int. Cl. B60C 9/08; B60C 13/00; B60C 9/00; B60C 9/18; B60C 9/02; B60C 15/00; B60C 11/00

(52) U.S. Cl. CPC B60C 9/08; B60C 15/0009; B60C 13/00; B60C 11/00; B60C 9/18; B60C 9/0207; B60C 9/0042; B60C 2009/0035; B60C 2009/0092; B60C 2009/0466

(57) ABSTRACT

A tire (10) comprises: a crown (12) surmounted by a tread (20), two sidewalls (22), two beads (24), each sidewall (22) connecting each bead (24) to the crown (12), a carcass reinforcement (32) anchored in each of the beads (24) and extending from each bead (24) through each sidewall (22) and comprising textile filamentary carcass reinforcing elements, a sidewall reinforcing reinforcement (25) comprising textile filamentary sidewall reinforcer reinforcing elements. R=max(K1,i)/min(K2,j)>1 where K1,i is the twist factor of each of the i carcass multifilament textile plied strands of each textile filamentary carcass reinforcing element, and K2,j is the twist factor of each of the j sidewall reinforcer multifilament textile plied strands of each textile filamentary sidewall reinforcer reinforcing element.

The subject of the invention is a tyre comprising a carcass ply and a sidewall reinforcing ply comprising textile filamentary reinforcing elements.

A conventional tyre comprising a carcass reinforcement comprising a carcass ply anchored in the bead by being turned up around an annular reinforcing structure so as to form a main strand extending from one bead to the other, through the crown of the tyre, and a turn up extending from the annular reinforcing structure radially outwards, is known from the prior art.

When this conventional tyre drives over the ground under the normal conditions of use (in terms of speed and load), it may experience shocks at the tread or the sidewalls, the frequency and intensity of which shocks are often considerable. It is one of the main functions of a tyre to absorb these shocks and damp them without the relevant wheel of the vehicle being significantly affected thereby either in terms of its movement or in terms of its integrity.

However, this ability to absorb shocks sometimes reaches its limit when the conditions of impact are such that the impacted wall of the tyre cover comes into abutment inside the pneumatic chamber either directly with the rim on which the tyre is mounted or, more usually, against another zone of the wall of the tyre cover which itself rests directly against the rim of the wheel. This is notably the case when the rim has an external radial projection with respect to the actual rim seat proper. Such a projection, usually referred to as a “rim flange” is generally provided so as to prevent the bead of the tyre from becoming unsuited under the effect of axially directed stresses during manoeuvres of the wheel.

A conventional tyre subjected to this type of incident is liable to suffer the consequences of the phenomenon that has just been described. In the section impacted by the shock, the internal wall of the tyre is suddenly folded and trapped between the obstacle and the rim flange (“pinch shock”). This may lead to the wall rupturing and the tyre then loses its inflation pressure which, most of the time, means that the vehicle is immediately immobilized. However, even when the tyre is able to resist, the components thereof may have been damaged by the incident; bulges in the sidewalls or other signs indicate to an expert that the structure of the tyre cover has been weakened and that there is a risk that the wall will rupture under the effect of the repeated bending of its components, in the fairly long term.

There have been a number of routes proposed for reinforcing tyres against this “pinch shock” phenomenon. To reinforce the conventional tyre described hereinabove with respect to “pinch shock” it is notably known practice to lengthen the turn up. The radially outer end of the carcass ply turn up extends back radially so that it is sandwiched between the main strand of the carcass ply and a crown reinforcement of the tyre. This design is known by the name of “shoulder lock”.

While a design of the “shoulder lock” type does effectively render the tyre less vulnerable to “pinch shock”, it has the disadvantage of being expensive and also of not allowing a very fine adjustment of the performance of the tyre. This is because the main strand and the lengthened turn up of the carcass ply each have textile filamentary reinforcing elements that are identical to those of the carcass ply of a conventional tyre that does not have a lengthened turn up, the purpose of this being to minimize the diversity of plies in industrial manufacturing processes.

The object of the invention is a tyre that is resistant to “pinch shock” and offers optimized endurance.

To this end, one subject of the invention is a tyre comprising:
a crown surmounted by a tread, two sidewalls, two beads, each sidewall connecting each bead to the crown,
a carcass reinforcement anchored in each of the beads and extending from each bead through each sidewall and comprising textile filamentary carcass reinforcing elements, each textile filamentary carcass reinforcing element comprising at least two carcass multifilament textile plied strands wound in a helix one about the other with a twist R1 expressed in turns per metre,
a sidewall reinforcement comprising textile filamentary sidewall reinforcer reinforcing elements, each textile filamentary sidewall reinforcer reinforcing element comprising at least two sidewall reinforcer multifilament textile plied strands wound in a helix one around the other with a twist R2 expressed in turns per metre, in which tyre R=max(K1,i)/min(K2,j)>1 where
K1,i is the twist factor of each of the i carcass multifilament textile plied strands of each textile filamentary carcass reinforcing element defined by K1,i=R1·[T1,i/(1000·d1,i)]^{1/2} in which T1,i, expressed in tex, is the count of each of the i carcass multifilament textile plied strands and d1,i is the density of the material in which each of the i carcass multifilament textile plied strands is made,
K2,j is the twist factor of each of the j sidewall reinforcer multifilament textile plied strands of each textile filamentary sidewall reinforcer reinforcing element defined by K2,j=R2·[T2,j/(1000·d2,j)]^{1/2} in which T2,j, expressed in tex, is the count of each of the j sidewall reinforcer multifilament textile plied strands and d2,j is the density of the material in which each of the j sidewall reinforcer multifilament textile plied strands is made.

The tyre according to the invention has both high resistance to “pinch shock” and optimized endurance as demonstrated by the comparative test results hereinafter.

Specifically, this objective is achieved by a tyre that combines an optimized carcass ply, which means to say one in which the twist factor of the textile filamentary carcass reinforcing elements is such that it is unable, by itself, under severe conditions of use, to fulfil certain functions, for example that of absorbing shocks, and a sidewall reinforcing ply in which the twist factor of the reinforcing elements is lower than the twist factor of the reinforcing elements of the carcass ply.

In addition, the functions of the carcass reinforcement of a conventional tyre are therefore performed by the combination of the carcass reinforcement and of the sidewall reinforcing reinforcement, thereby making it possible to optimize each of these plies separately and obtain a better performance/cost ratio.

Furthermore, combining a carcass reinforcement with a sidewall reinforcing reinforcement as defined in the invention makes it possible to reduce the cost and the mass of the tyre and increase the robustness thereof while at the same time giving the designer greater flexibility.

The tyre according to the invention makes it possible to reinforce the carcass reinforcement in the places where it is highly stressed (namely in the sidewalls) while at the same time reducing its strength (and therefore cost) in the region in which it is only stressed a little (namely in the crown), unlike a tyre of the “shoulder lock” design which merely doubles up on the main strand using a lengthened turn up in the sidewall with identical filamentary reinforcing elements. Therefore the shorter the sidewall and the broader the crown the more advantageous the tyre according to the invention is.

A filamentary element means any longilinear element. The length of which is great relative to the cross section thereof, regardless of the shape of this cross section, be it for example circular, oblong, rectangular or square or even flat, it being possible for this filamentary element to be rectilinear or non-rectilinear. When circular in shape its diameter is preferably smaller than 5 mm, more preferably comprised in a range from 0.1 to 2 mm.

The reinforcing element is also referred to as a plied yarn. Each multifilament textile plied strand is also referred to as an overtwist and comprises a plurality of elementary filaments or monofilaments which may be intermingled with one another. Each multifilament textile plied strand comprises between 50 and 2000 monofilaments.

Textile means that the filamentary reinforcing elements are non-metallic, namely are not made of a metallic material.

The value max(K1,i) corresponds to the maximum value of the K1,i twist factors of each of the i carcass multifilament textile plied strands. The value min(K2,j) corresponds to the minimum value of the K2,j twist factors of each of the j sidewall reinforcer multifilament textile plied strands.

The density of the material in which each of the multifilament textile plied strands is made is measured using conventional techniques known to those skilled in the art, for example using a density column.

The count (or linear density) of the elementary strands or of the reinforcing elements is determined on at least two test specimens, each corresponding to a length of at least 5 m, by weighing this length; the count is given in tex (weight in grams of 1000 m of product—remember: 0.111 tex is equal to 1 denier).

The twist of each textile filamentary reinforcing element is measured in a way known to those skilled in the art, for example by untwisting a predetermined length of the textile filamentary element until the two multifilament textile plied strands are parallel. The number of turns needed to obtain the two parallel multifilament textile plied strands divided by the predetermined length gives the twist R1 or R2 of each textile filamentary reinforcing element.

Advantageously, R≧1.05, preferably R≧1.10, more preferably R≧1.30 and more preferably still, R≧1.40. The higher the ratio R, the better the endurance of the tyre.

Advantageously, R≦2, preferably R≦1.75, and more preferably, R≦1.6. However, beyond a certain ratio R, there is a risk that the carcass ply will no longer be able to perform its functions.

Advantageously, the ratio R′=Fm1/Fm2 in which Fm1 is the force at rupture of the carcass reinforcement and Fm2 is the force at rupture of the sidewall reinforcing reinforcement is less than 1, preferably less than or equal to 0.8 and more preferably, less than or equal to 0.6.

Advantageously, the ratio R′=Fm1/Fm2 is greater than or equal to 0.4, preferably greater than or equal to 0.5, and more preferably, greater than or equal to 0.6.

The force at rupture of each of the textile filamentary reinforcing elements is determined on the elements after they have been extracted from the cured tyre. To do that, the elastomer matrix or matrices in which the textile filamentary reinforcing elements are embedded is or are removed and the elements are stripped from the tyre, taking care not to damage them. The use of solvents will be avoided which means that the elements remain partially coated with elastomer matrix. When the elements are made of rayon, they are dried for 120±15 min at a temperature of 105±4.5° C. The elements are then conditioned at 23±2° C., at a relative humidity of 27±10% for a length of time that is dependent on the nature of the elements:
for rayon: at least 5 days and at most 15 days;
for nylon and nylon-based hybrids: at least 3 days;
for others (notably PET and aramids): at least 1 day.

The force at rupture of each textile filamentary reinforcing element is measured using an “INSTRON” tensile test machine (see also standard ASTM D 885-06). The tested test specimens undergo tension over an initial length L0 (in mm) at a nominal rate of L0 mm/min under a standard preload 5 of 1 cN/tex (averaged over at least 10 measurements). The force at rupture adopted for each textile filamentary reinforcing element is the maximum force measured. The force of rupture for each reinforcement (in daN·cm⁻¹) is obtained by multiplying this force at rupture of each textile filamentary reinforcing element by the number of the textile filamentary reinforcing elements present per cm of reinforcement.

For preference, for each textile filamentary carcass reinforcing element, 90≦T1,i≦250 and 340≦R1≦440. For preference 110≦T1,i≦170 and 390≦R1≦450 in certain embodiments. For preference 190≦T1,i≦250 and 340≦R1≦400 in other embodiments. For preference 90≦T1,i≦140 and 370≦R1≦430 in still other embodiments.

For preference, for each sidewall reinforcer textile filamentary reinforcing element, 120≦T2,i≦360 and 220≦R2≦310. For preference 190≦T2,i≦250 and 210≦R2≦270 in certain embodiments. For preference 110≦T2,i≦170 and 260≦R2≦320 in other embodiments. For preference, 300≦T2,i≦360 and 240≦R2≦300 in other embodiments still.

For preference, the carcass multifilament textile plied strands are made from the same material. For preference also, the sidewall reinforcing multifilament textile plied strands are made from the same material.

For preference, the carcass multifilament textile plied strands have the same twist. For preference also, the sidewall reinforcer multifilament textile plied strands have the same twist.

For preference, the carcass multifilament textile plied strands have the same count. For preference also, the sidewall reinforcer multifilament textile plied strands have the same count.

Advantageously, the twist factor K1,i of each carcass multifilament textile plied strand is comprised in a range of values extending from 100 to 155. In certain embodiments, K1,i is comprised within a range of values extending from 125 to 155. In other embodiments, K1,i is comprised in a range of values ranging from 100 to 120.

Advantageously, the twist factor K2,j of each sidewall reinforcer multifilament textile plied strand is comprised in a range of values extending from 80 to 150. In certain embodiments, K2,j is comprised in a range of values extending from 90 to 105. In other embodiments, K2,j is comprised in a range of values extending from 125 to 150.

In one preferred embodiment, the carcass reinforcement is axially discontinuous, the discontinuity extending axially at least partially under the crown. Because the carcass reinforcement plays little or no part in the operation of the crown of the tyre, it is possible to dispense with it in this part of the tyre. This embodiment is all the more advantageous when the textile reinforcing elements of the discontinuous carcass reinforcement have a rupture strength that is also high enough to perform the functions of a conventional carcass reinforcement. In this embodiment, the tyre comprising a crown reinforcement interposed radially between the carcass reinforcement and the tread, the axially discontinuous carcass reinforcement comprises two axially inner ends each one arranged axially on the inside of the axially outer end of the radially adjacent crown ply. More preferably, the distance between the axially outer end of the radially adjacent crown ply and the axially internal end of the carcass reinforcement is greater than or equal to 10 mm.

For preference, the carcass reinforcement comprises a single carcass ply.

For preference, the sidewall reinforcing reinforcement comprises a single sidewall reinforcing ply.

Advantageously, the carcass reinforcement is anchored in each bead by being turned up around an annular structure of the bead so as to form a main strand and a turn up.

In one embodiment, the sidewall reinforcing reinforcement extends, in the bead, axially between the main strand and the turn up of the carcass reinforcement. Thus, the sidewall reinforcing reinforcement is held between the main strand and turn up of the carcass reinforcement and therefore good at reacting tension.

In another embodiment, the sidewall reinforcing reinforcement extends, in the bead, axially on the outside of the turn up.

For preference, the radially inner end of the sidewall reinforcing reinforcement is radially on the inside of the radially outermost point of the carcass reinforcement turn up.

In one preferred embodiment, the radial distance between the radially inner end of the sidewall reinforcing reinforcement and the radially outermost point of the carcass reinforcement turn up is greater than or equal to 10 mm.

Advantageously, the tyre comprises a crown reinforcement radially interposed between the carcass reinforcement and the tread.

For preference, with the crown reinforcement comprising at least one crown ply, the radially outer end of the sidewall reinforcing reinforcement is axially on the inside of the axially outer end of the crown ply radially adjacent to the sidewall reinforcing reinforcement. Thus, the sidewall reinforcing reinforcement is held under the crown ply radially adjacent to it, thereby allowing it to react tension correctly and relieve the load on the carcass reinforcement.

In one preferred embodiment, the axial distance between the radially outer end of the sidewall reinforcing reinforcement and the axially outer end of the crown ply radially adjacent to the sidewall reinforcing reinforcement is greater than or equal to 10 mm.

In some embodiments, the crown reinforcement comprises, considering it in the direction radially towards the outside of the tyre, a working reinforcement and a hoop reinforcement. Alternatively, the crown reinforcement comprises, considering it radially towards the outside of the tyre, a working reinforcement and a protective reinforcement. There may also be a crown reinforcement comprising, considering it radially towards the outside of the tyre, a working reinforcement, a hoop reinforcement and a protective reinforcement.

According to one particular embodiment, the textile filamentary sidewall reinforcer reinforcing elements are oriented substantially radially. This design makes it possible to maintain the overall compromise in performance associated with the radial structure of the carcass reinforcement (compromise between comfort, rolling resistance, behaviour, etc.) while improving the “pinch shock” performance.

According to one particular embodiment, the textile filamentary sidewall reinforcer reinforcing elements are inclined by an angle of between 40° and 80°, and preferably between 40° and 50°, with respect to the radial direction. This design makes it possible to increase the vertical stiffness, something that is beneficial for “pinch shock” performance, while at the same time also orienting the reinforcing elements in such a way as to encourage the reaction of longitudinal tension, thereby making it possible to improve their resistance to kerbing.

As an option, the textile filamentary carcass and/or sidewall reinforcer reinforcing elements are made from a material selected from a polyester, such as polyethylene terephthalate (PET), polyethylene naphthalate (PEN), polybutylene terephthalate (PBT), polybutylene naphthalate (PBN), polypropylene terephthalate (PPT) or polypropylene naphthalate (PPN), a polyamide, for example an aliphatic polyamide such as nylon or an aromatic polyamide such as aramid, a polyketone, a cellulose such as rayon or a mixture of these materials. For preference, the textile filamentary carcass and/or sidewall reinforcer reinforcing elements are made from a material selected from a polyester, a polyamide, a cellulose or a mixture of these materials.

It is thus possible to contemplate hybrid textile filamentary carcass and/or sidewall reinforcer reinforcing elements made of aramid/nylon or even of aramid/PET.

Optionally, the tyre comprises an airtight inner liner, the airtight inner liner being at least partially covered with a layer of a self-sealing product.

The presence of the self-sealing product allows the tyre better to withstand the damaging effects of a puncture. In other words, the vast majority of punctures will have no effect on the internal inflation pressure. In instances in which this layer is unable to avoid the loss of tyre pressure, it has been found that the presence of this layer significantly increases the distance that the tyre can cover as it runs flat by maintaining the possibility to steer the vehicle because the beads remain in place on the rim seats. The presence of the self-sealing product in effect makes it possible to slow down the damage to the sidewalls of the tyre, notably through a lubricating effect. This tyre thus allows the vehicle, whatever the severity of a puncture or blowout, to continue to drive for at least a few kilometres thereby allowing it to leave a dangerous area.

The layer of self-sealing product may contain at least one thermoplastic styrene (“TPS”) elastomer, and more than 200 phr of an extension oil for said elastomer, “phr” meaning parts by weight per hundred parts of solid rubber.

The TPS may be the predominant elastomer in the layer of self-sealing product.

The TPS elastomer may be selected from the group consisting of styrene/butadiene/styrene (SBS), styrene/isoprene/styrene (SIS), styrene/isoprene/butadiene/styrene (SIBS), styrene/ethylene/butylene/styrene (SEBS), styrene/ethylene/propylene/styrene (SEPS), styrene/ethylene/ethylene/propylene/styrene (SEEPS) copolymers and mixtures of these copolymers.

Advantageously, the TPS elastomer is selected from the group consisting of SEBS copolymers, SEPS copolymers and mixtures of these copolymers.

According to another embodiment, the layer of self-sealing product may contain at least (phr meaning parts by weight per hundred parts of solid rubber):

(a) by way of predominant elastomer, an unsaturated diene elastomer;
(b) between 30 and 90 phr of a hydrocarbon resin;
(c) a liquid plasticizer of which the Tg (glass transition temperature) is below −20° C., in a content by weight of between 0 and 60 phr; and
(d) from 0 to under 120 phr of a filler.

The unsaturated diene elastomer is advantageously selected from the group consisting of polybutadienes, natural rubber, synthetic polyisoprenes, butadiene copolymers, isoprene copolymers and mixtures of such elastomers.

The unsaturated diene elastomer may advantageously be an isoprene elastomer, preferably selected from the group consisting of natural rubber, synthetic polyisoprenes and mixtures of such elastomers.

Advantageously, the unsaturated diene elastomer content is greater than 50 phr, preferably greater than 70 phr.

The tyre is preferably intended for passenger cars, two-wheelers, vans or industrial vehicles selected from vans, heavy vehicles such as heavy industrial vehicles—i.e. metro vehicles, buses, road haulage vehicles (lorries, tractors, trailers), off-road vehicles—agricultural or construction plant vehicles, aircraft, other transport or handling vehicles.

For preference, in a plane of radial section of the tyre, namely a plane of section parallel to the radial direction, the distance between the axially internal surface of the tyre and the axially internal surface of the axially outermost reinforcing ply is, at the equator of the tyre, less than or equal to 6 mm, preferably 5 mm. The reinforcing ply is a ply containing textile and/or metallic reinforcing elements. The reinforcing ply may be a carcass ply or a sidewall reinforcing ply. Thus, the tyre is preferably not a run-flat tyre. In other words, the sidewalls do not have rubber inserts for supporting load at reduced or even no pressure.

The axially internal surface of the tyre defines the inflation volume delimited by the tyre.

The “equator” of the tyre means the radial height of the point of greatest axial extension of the carcass reinforcement. In a radial section of the tyre the equator appears as the axial straight line passing through the points at which the carcass reinforcement has its greatest axial width when the tyre is mounted on the rim and inflated. When the carcass reinforcement reaches this greatest axial width at a number of points, the equator of the tyre is considered to be the radial height of the point closest to mid-height H/2 of the tyre. The equator thus defined must not be confused with the median plane of the tyre.

The invention will be better understood from reading the following description given solely by way of nonlimiting example and made with reference to the drawings in which:

FIG. 1 is a view in section of a tyre according to a first embodiment of the invention;

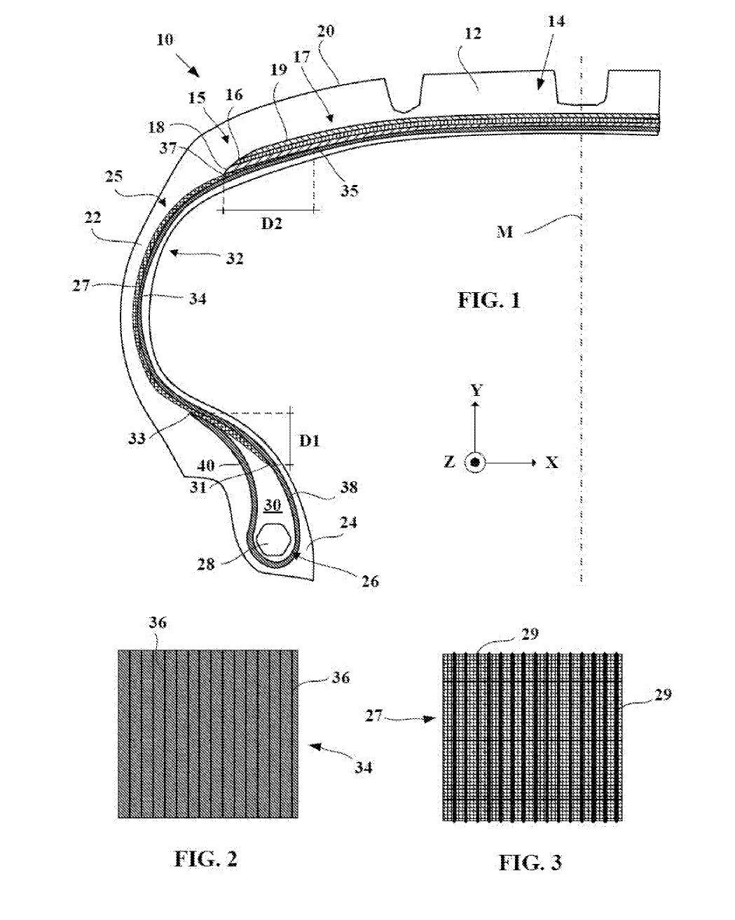

FIG. 2 is a schematic view of part of the carcass ply of the tyre of FIG. 1;

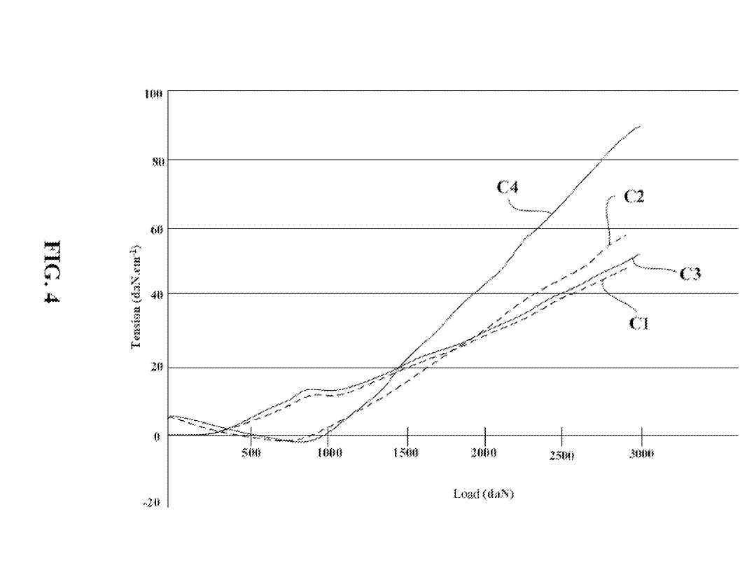

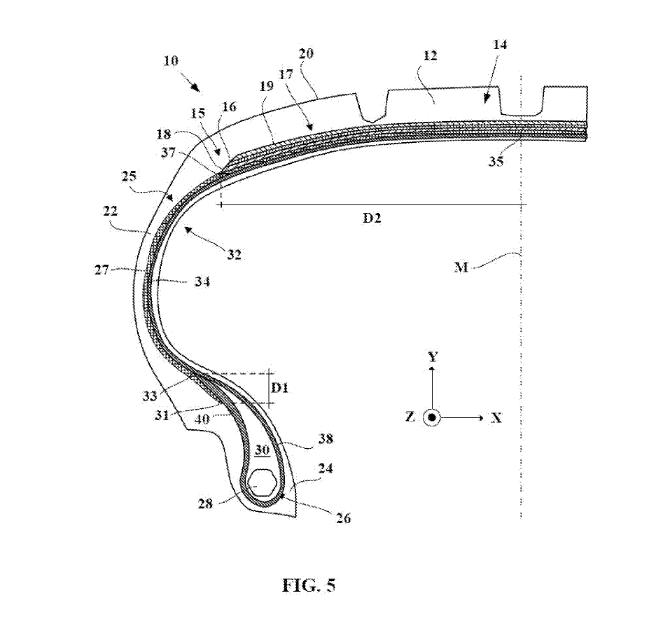

FIG. 3 is a schematic view of part of the sidewall reinforcing ply of the tyre of FIG. 1;

FIG. 4 is an indication of the tension as a function of the load applied to various tyre plied yarns, notably carcass plied yarns and sidewall reinforcing plied yarns;

FIGS. 5, 6, 7 and 8 are views analogous to FIG. 1 of tyres according to second, third, fourth and ninth embodiments respectively; and

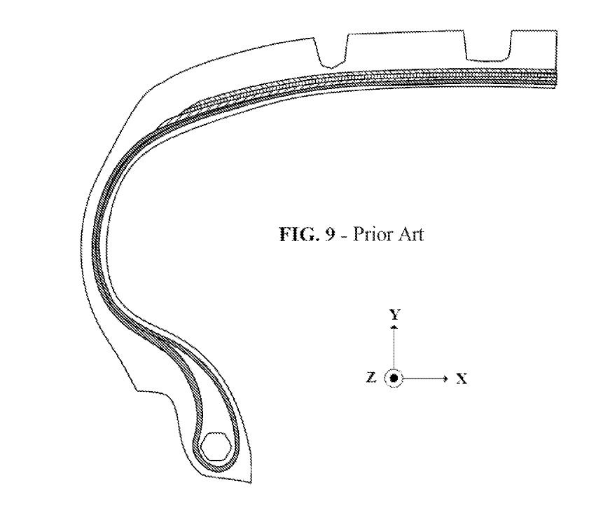

FIG. 9 is a view analogous to that of FIG. 1 of a tyre according to the prior art exhibiting a design of the “shoulder lock” type.

In the description that follows, when using the word “radial” it is appropriate to make a distinction between the various uses made of this word by those skilled in the art. Firstly, the expression refers to a radius of the tyre. It is in this sense that a point P1 is said to be “radially inside” a point P2 (or “radially on the inside of” the point P2) if it is closest to the axis of rotation of the tyre that is the point P2. Conversely, a point P3 is said to be “radially outside” of a point P4 (or “radially on the outside of” the point P4) if it is further away from the axis of rotation of the tyre than the point P4. Progress will be said to be “radially inwards (or outwards)” when it is in the direction towards smaller (or larger) radii. It is this sense of the term that applies also when matters of radial distances are being discussed.

By contrast, a reinforcing element or reinforcement is said to “radial” when the reinforcing element or the reinforcing elements of the reinforcement make an angle greater than or equal to 65° and less than or equal to 90° with the circumferential direction.

An “axial” direction is a direction parallel to the axis of rotation of the tyre. A point P5 is said to be “axially inside” a point P6 (or “axially on the outside of” the point P6) if it is closer to the mid-plane M of the tyre than the point P6. Conversely, a point P7 is said to be “axially outside” of a point P8 (or “axially on the outside of” the point P8) if it is further from the median plane M of the tyre than the point P8.

The “median plane” M of the tyre is the plane which is normal to the axis of rotation of the tyre and situated equidistant from the annular reinforcing structures of each bead.

Furthermore, any range of values denoted by the expression “from a to b” means the range of values extending from the end point “a” to the end point “b”, namely including the strict end points “a” and “b”.

### EXAMPLES OF TYRES ACCORDING TO THE INVENTION

The figures depict a frame of reference X, Y, Z corresponding to the usual respectively axial (X), radial (Y) and circumferential (Z) orientations of a tyre.

FIG. 1 depicts a tyre according to a first embodiment of the invention and denoted by the general reference 10. The tyre 10 substantially exhibits symmetry of revolution about an axis substantially parallel to the axial direction X. The tyre 10 here is intended for a passenger vehicle.

The tyre 10 comprises a crown 12 comprising a crown reinforcement 14 comprising a working reinforcement 15 comprising two working plies 16, 18 of reinforcing elements and a hoop reinforcement 17 comprising a hoop ply 19. The crown reinforcement 14 is surmounted by a tread 20. The hoop reinforcement 17, in this instance the hoop ply 19, is interposed radially between the working reinforcement 15 and the tread 20.

Two sidewalls 22 extend the crown 12 radially inwards. The tyre 10 further comprises two beads 24 radially on the inside of the sidewalls 22 and each comprising an annular reinforcing structure 26, in this instance a bead wire 28, surmounted by a mass of filling rubber 30 and a radial carcass reinforcement 32. The crown reinforcement 14 is interposed radially between the carcass reinforcement 32 and the tread 20. Each sidewall 22 connects each bead 24 to the crown 14. The tyre 10 also comprises a radial sidewall reinforcing reinforcement 25 preferably comprising a single sidewall reinforcing ply 27 of radial textile filamentary sidewall reinforcer reinforcing elements 29.

The carcass reinforcement 32 preferably comprises a single carcass ply 34 of radial textile filamentary carcass reinforcing elements 36. The carcass reinforcement 32 is anchored to each of the beads 24 by being turned up around the bead wire 28 so as to form, within each bead 24, a main strand 38 extending from each bead 24 through each sidewall 22 towards the crown 12, and a turn up 40. The carcass reinforcement 32 thus extends from the beads 24 through the sidewalls 22 towards the crown 12. In this first embodiment, the carcass reinforcement 32 also extends through the crown 12.

With reference to FIG. 2, each textile filamentary carcass reinforcing element 36 comprises two carcass multifilament textile plied strands. Each carcass multifilament textile plied strand is made of polyester, in this instance PET, which are individually overtwisted at 420 turns·m⁻¹ in one direction then plied together at R1=420 turns·m⁻¹ in the opposite direction. The two carcass multifilament textile plied strands are wound in a helix one around the other. Each carcass multifilament textile plied strand has a count T1=144 tex.

With reference to FIG. 3, each textile filamentary sidewall reinforcement reinforcing element 29 comprises two sidewall reinforcement multifilament textile plied strands. Each sidewall reinforcement multifilament textile plied strand is made of polyester, in this instance PET, and are individually overtwisted at 240 turns·m⁻¹ in one direction then plied together at R2=240 turns·m⁻¹ in the opposite direction. The two sidewall reinforcement multifilament textile plied strands are wound in a helix one around the other. Each carcass multifilament textile plied strand has a count T2=220 tex. The PET used for each textile filamentary reinforcing element 36 and 29 is marketed by the Performance Fibers company.

In order to manufacture the reinforcing elements by plying, it will be recalled here simply, as is well known to those skilled in the art, that each multifilament textile plied strand of which the final reinforcing element is to be made is first of all twisted individually on itself in a given direction (for example Z-twisting at Y turns per metre of plied strand) during a first step to form an overtwist, and then that the multifilament textile plied strands thus twisted on themselves are then plied together by twisting in the opposite direction (for example by S-twisting of R turns per metre of reinforcing element) to form a plied yarn, in this instance the final reinforcing element.

The twist prior to the plying of each multifilament textile plied strand can be measured on the final reinforcing element by untwisting the multifilament textile plied strands of which the reinforcing element is made (for example by the untwisting in the Z direction of R turns per metre of reinforcing element) until the reinforcing element no longer exhibits any twist, then by untwisting each multifilament textile plied strand (for example by the untwisting in the S direction of Y turns per metre) until each multifilament textile plied strand no longer exhibits any twist. The number of turns per metre R, Y needed for these two untwisting operations then respectively yields the assembly twist of the reinforcing element (in this instance R=R1=420 for the elements 36 and R=R2=240 for the elements 29) and the twist that each multifilament textile plied strand had before the two plied strands were plied together (in this instance Y=420 in the case of the elements 36 and Y=240 in the case of the elements 29). In this particular instance R=Y for the elements 36 on the one hand and for the elements 29 on the other.

The sidewall reinforcing reinforcement 25 is arranged axially on the outside of the main strand 38 and extends, in each bead 24, axially between the main strand 38 and the turn up 40 of the carcass reinforcement 32.

The radially inner end 31 of the sidewall reinforcing reinforcement 25 is radially on the inside of the radially outermost point 33 of the turn up 40 of the carcass reinforcement 32. In this particular instance, the radial distance D1 between the radially inner end 31 of the sidewall reinforcing reinforcement 25 and the radially outermost point 33 of the turn up 40 of the carcass reinforcement 32 is greater than or equal to 10 mm, in this case equal to 10 mm.

The radially outer end 35 of the sidewall reinforcing reinforcement 25 is axially on the inside of the axially outer end 37 of the crown ply radially adjacent to the sidewall reinforcing reinforcement 25, in this instance the radially innermost working ply 18. The axial distance D2 between the radially outer end of the sidewall reinforcing reinforcement and the axially outer end 37 of the radially adjacent crown ply, in this instance the working ply 18, at the sidewall reinforcing reinforcement 25 is greater than or equal to 10 mm, in this case equal to 10 mm.

The ratio R=max(K1,i)/min(K2,j) is strictly greater than 1, where:
K1,i is the twist factor of each of the i carcass multifilament textile plied strands of each textile filamentary carcass reinforcing element defined by K1,i=R1·[T1,i/(1000·d1,i)]^{1/2} in which T1,i, expressed in tex, is the count of each of the i carcass multifilament textile plied strands and d1,i is the density of the material in which each of the i carcass multifilament textile plied strands is made,
K2 is the twist factor of each of the j sidewall reinforcer multifilament textile plied strands of each textile filamentary sidewall reinforcer reinforcing element defined by K2,j=R2·[T2,j/(1000·d2,j)]^{1/2} in which T2,j, expressed in tex, is the count of each of the j sidewall reinforcer multifilament textile plied strands and d2,j is the density of the material in which each of the j sidewall reinforcer multifilament textile plied strands is made.

The densities are commonly as follows: 1.44 for aramid, 1.25 to 1.40 for polyesters and 1.38 for PET.

The carcass multifilament textile plied strands have the same twist, the same count and are both made of polyester. Thus, max(K1,i)=K1,1=K1,2=K1.

Similarly, the sidewall reinforcer multifilament textile plied strands have the same twist, the same count and are both made of polyester. Thus, min(K2,j)=K2,1=K2,2=K2.

R≧1.05, preferably R≧1.10, more preferably R≧1.30 and more preferably still, R≧1.40. Also, R≦2, preferably R≦1.75, and more preferably, R≦1.6. In the first embodiment, K1=135.67 and K2=95.83 namely R=K1/K2=1.42.

The ratio R′=Fm1/Fm2 in which Fm1 is the force at rupture of the carcass reinforcement 32 and Fm2 is the force at rupture of the sidewall reinforcing reinforcement 25 is less than 1, preferably less than or equal to 0.8. The ratio R′=Fm1/Fm2 is greater than or equal to 0.4, preferably greater than or equal to 0.5 and more preferably, greater than or equal to 0.6. In this instance R′=0.68.

Each working ply 16, 18 comprises filamentary, preferably metallic, reinforcing elements forming an angle ranging from 15° and 40°, preferably ranging from 20° to 30° and here equal to 26° with the circumferential direction of the tyre. The filamentary reinforcing elements are crossed from one working ply with respect to the other.

The hooping ply 19 comprises textile filamentary reinforcing elements making an angle at most equal to 10°, preferably ranging from 5° to 10° with the circumferential direction Z of the tyre 10.

Each working ply 16, 18, hooping ply 19, sidewall reinforcing ply 27 and carcass ply 34 comprises an elastomer matrix in which the reinforcing elements of the corresponding ply are embedded. The rubber compositions of the elastomer matrices of the working plies 16, 18, hooping ply 19, sidewall reinforcing ply 27 and carcass ply 34 are conventional compositions commonly used for calendering reinforcing elements comprising in the conventional way a diene elastomer, for example natural rubber, a reinforcing filler, for example carbon black and/or silica, a cross-linking system, for example a vulcanization system, preferably containing sulphur, stearic acid and zinc oxide and possibly a vulcanization accelerator and/or retarder and/or various additives.

FIG. 4 shows results of calculations regarding a tyre sidewall subjected to extensive deformation. The tension T (in daN·cm⁻¹) has been plotted as a function of load Z (in daN). Curves C1 and C2 (in dotted line) corresponds to the tyre T of FIG. 9 comprising textile filamentary carcass reinforcing elements and sidewall reinforcing elements made of PET with T1=T2=144 tex and R1=R2=420 turns·m⁻¹.

Each curve C1, C2 (in dotted line) represents the tension reacted by the textile filamentary reinforcing elements of the main strand and of the turn up respectively of the carcass reinforcement of the tyre T of FIG. 9.

Each curve C3, C4 (continuous line) represents the tension reacted by the textile filamentary reinforcing elements of the carcass reinforcement and of the sidewall reinforcing reinforcement respectively of the tyre 10 according to the first embodiment.

The total rupture force of carcass reinforcements and sidewall reinforcing reinforcements of the tyre according to the invention is slightly higher than the total rupture force of the main strand and turn up of the tyre T so that the tyre according to the invention ruptures at slightly higher loads than the tyre T but has an endurance that is far superior to the tyre T, this being for the same mass, as the tests hereinafter demonstrate, thereby clearly illustrating the benefit of combining an “under dimensioned” carcass reinforcement with a sidewall reinforcing reinforcement that satisfies R=max(K1,i)/min(K2,j)>1.

FIG. 5 depicts a tyre according to a second embodiment of the invention. The elements analogous to those depicted in FIG. 1 are denoted by identical references.

In contrast with the tyre according to the first embodiment, the sidewall reinforcing reinforcement 25 extends, in the bead 24, axially on the outside of the turn up 40.

In addition, the sidewall reinforcing reinforcement 25 extends, under the crown 12, axially at least as far as the median plane M of the tyre 10. In this particular instance, the tyre 10 comprises a single sidewall reinforcing reinforcement 25 extending from one bead 24 of the tyre 10 to the other, passing through the median plane M of the tyre 10. As an alternative, it may be conceivable to have two sidewall reinforcing reinforcements 25 extending from each bead 24 and meeting substantially at the median plane M of the tyre 10.

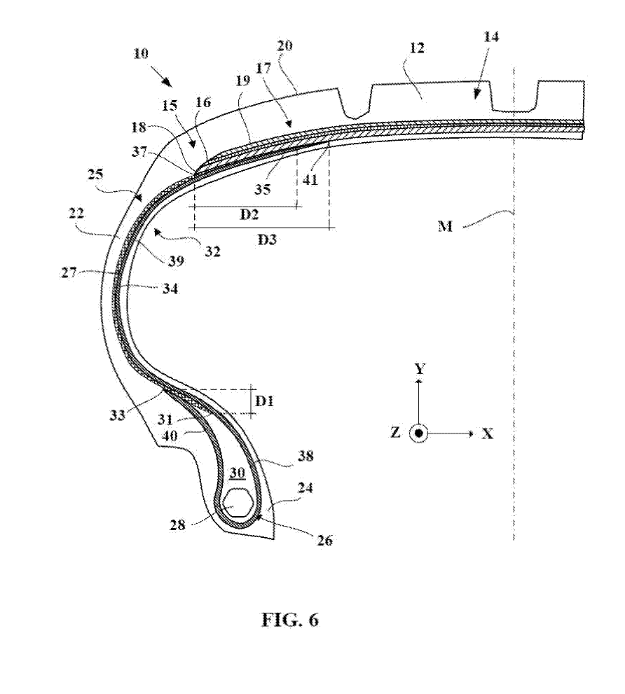

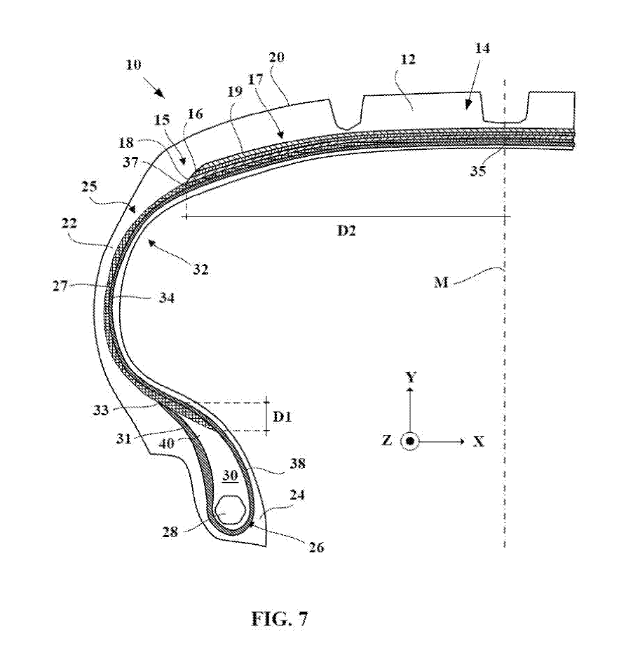

FIG. 6 depicts a tyre according to a third embodiment of the invention. Elements analogous to those depicted in the preceding figures are denoted by identical references.

In contrast with the tyres according to the first and second embodiments, the tyre according to the third embodiment comprises an axially discontinuous carcass reinforcement 32. The carcass reinforcement 32 has a discontinuity extending axially partially under the crown 12.

The axially discontinuous carcass reinforcement 32 comprises two carcass plies 39, each one comprising an axially internal end 41 arranged axially on the inside of the axially outer end 37 of the radially adjacent crown ply, in this instance the ply 18. Here, the distance D3 between the axially outer end 37 of the radially adjacent crown ply 18 and the axially internal end 41 of the carcass reinforcement 32 is greater than or equal to 10 mm and in this case D3=12 mm.

FIG. 7 depicts a tyre according to a fourth embodiment of the invention. Elements analogous to those depicted in the preceding figures are denoted by identical references.

In contrast with the second embodiment and as in the first embodiment, the sidewall reinforcing reinforcement 25 of the tyre 10 according to the fourth embodiment is arranged axially on the outside of the main strand 38 and extends, in each bead 24, axially between the main strand 38 and the turn up 40 of the carcass reinforcement 32.

As in the second embodiment, the sidewall reinforcing reinforcement 25 extends, under the crown 12, axially at least as far as the median plane M of the tyre 10. In this particular instance, the tyre 10 comprises a single sidewall reinforcing reinforcement 25 extending from one bead 24 of the tyre 10 to the other, passing through the median plane M of the tyre 10.

It is also conceivable to have a tyre according to a fifth embodiment (not depicted) in which, in contrast with the tyre according to the first embodiment, T1=220 tex, R1=370 turns·m−1 and T2=220 tex, R2=240 turns·m−1. In that case R=max(K1,i)/min(K2,j) strictly greater than 1, preferably R≧1.05, more preferably R≧1.10, even more preferably R≧1.30 and even more preferably still, R≧1.40. Because K1,1=K1,2=K1 and K2,1=K2,2=K2, R=K1/K2=147.73/95.83=1.54. R′ is less than 1, in this case R′=0.96.

It is also conceivable to have a tyre according to a sixth embodiment (not depicted) in which, in contrast with the tyre according to the first embodiment, T1=110 tex, R1=394 turns·m⁻¹ and T2=144 tex, R2=290 turns·m⁻¹. Then R=max(K1,i)/min(K2,j) strictly greater than 1, preferably R≧1.05, more preferably R≧1.10. Since K1,1=K1,2=K1 and K2,1=K2,2=K2, R=K1/K2=111.24/93.68=1.19. Also R′=0.64.

It is also conceivable to have a tyre according to a seventh embodiment (not depicted) in which, in contrast with the tyre according to the first embodiment, the ratio R′=Fm1/Fm2 is less than 1, preferably less than or equal to 0.8 and more preferably still, less than or equal to 0.6 and greater than or equal to 0.4, preferably greater than or equal to 0.5. In this seventh embodiment, R′=0.59.

It is also conceivable to have a tyre according to an eighth embodiment (not depicted) in which, in contrast with the tyre according to the first embodiment, T1=144 tex, R1=420 turns·m⁻¹ and T2=334 tex, R2=270 turns·m⁻¹. Then R=max(K1,i)/min(K2,j) strictly greater than 1. Since K1,1=K1,2=K1 and K2,1=K2,2=K2, R=K1/K2=135.67/132.83=1.02. Also R′=Fm1/Fm2 greater than or equal to 0.4, preferably greater than or equal to 0.5 and in this case R′=0.67.

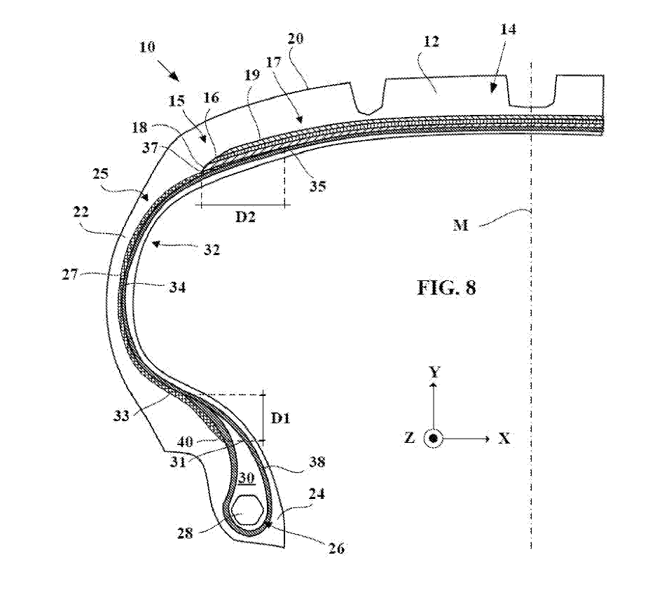

FIG. 8 depicts a tyre according to a ninth embodiment of the invention. Elements analogous to those depicted in the preceding figures are denoted by identical references.

In contrast with the tyre according to the first embodiment, the sidewall reinforcing reinforcement 25 extends, in the bead 24, axially on the outside of the turn up 40.

Tables 1 and 2 below collate the various features of the carcass and sidewall reinforcing plied strands of the tyres according to the first, fifth, sixth, seventh and eighth embodiments described hereinabove, denoted 10₁, 10₅, 10₆, 10₇ and 10₈. The characteristics of the tyre T of the prior art are also recorded.

It will be noted that, for each textile filamentary carcass reinforcing element 36, 90≦T1,i≦250 and 340≦R1≦440. For preference 110≦T1,i≦170 and 390≦R1≦450 for the first, seventh and eighth embodiments. For preference 190≦T1,i≦250 and 340≦R1≦400 for the fifth embodiment. For preference, 90≦T1,i≦140 and 370≦R1≦430 for the sixth embodiment.

It will be also noted that, for each textile filamentary sidewall reinforcer reinforcing element 29, 120≦T2,i≦360 and 220≦R2≦310. For preference, 190≦T2,i≦250 and 210≦R2≦270 for the first, fifth and seventh embodiments. For preference 110≦T2,i≦170 and 260≦R2≦320 for the sixth embodiment. For preference, 300≦T2,i≦360 and 240≦R2≦300 for the eighth embodiment.

It will be noted that the twist factor K1,i for each carcass multifilament textile plied strand is comprised in a range of values ranging from 100 to 155. For preference, K1,i comprised in a range of values extending from 125 to 155 for the first, fifth, seventh and eighth embodiments and from 100 to 120 for the sixth embodiment.

It will be noted that the twist factor K2,j of each sidewall reinforcer multifilament textile plied strand is comprised in a range of values extending from 80 to 150. For preference, K2,j is comprised within a range of values extending from 90 to 105 for the first, fifth, sixth and seventh embodiments and from 125 to 150 for the eighth embodiment.

TABLE 1

| | T | | 10₁ | | 10₅ | |
|---|---|---|---|---|---|---|
| | | Sidewall | | Sidewall | | Sidewall |
| | Carcass | reinforcer | Carcass | reinforcer | Carcass | reinforcer |
| T1, i, | 144 | 144 | 144 | 220 | 220 | 220 |
| T2, j | | | | | | |
| R1, R2 | 420 | 420 | 420 | 240 | 370 | 240 |
| K1, i, | 136 | 136 | 136 | 96 | 148 | 96 |
| K2, j | | | | | | |

| | | | |
|---|---|---|---|
| R | 1 | 1.42 | 1.54 |
| R′ | 1 | 0.68 | 0.96 |

TABLE 2

| | 10₆ | | 10₇ | | 10₈ | |
|---|---|---|---|---|---|---|
| | | Sidewall | | Sidewall | | Sidewall |
| | Carcass | reinforcer | Carcass | reinforcer | Carcass | reinforcer |
| T1, i, | 110 | 144 | 144 | 220 | 144 | 334 |
| T2, j | | | | | | |
| R1, R2 | 394 | 290 | 420 | 240 | 420 | 270 |
| K1, i, | 111 | 94 | 136 | 96 | 136 | 133 |
| K2, j | | | | | | |

| | | | |
|---|---|---|---|
| R | 1.19 | 1.42 | 1.02 |
| R′ | 0.64 | 0.59 | 0.67 |

Comparative Tests

A tyre T of the prior art depicted in FIG. 9 and two tyres according to the first and eighth embodiments of the invention, denoted 10₁ and 10₈ respectively, were compared. Each test tyre T and tyre according to the invention was of size 245/40R18.

The tyre T comprises carcass and sidewall reinforcer plies each comprising carcass and sidewall reinforcer reinforcing elements that are identical. The characteristics of these tyres T, 10₁ and 10₈ are collated in Table 3 below.

The mass of each tyre was measured. The values obtained were converted with respect to the tyre T of the prior art which is equivalent to a value of 100. The greater the extent to which the value is higher than 100, the lighter is the tyre in comparison with the tyre T of the prior art.

The initial force at rupture Fi of the sidewall reinforcing and carcass reinforcements of each tyre were measured before running. The residual force at rupture Fr of the carcass and sidewall reinforcing reinforcements of each tyre were also measured after running for 35,000 km. The values obtained were converted with reference to the tyre T of the prior art which is equivalent to a value of 100. The greater the extent to which the value is higher than 100, the better the initial or residual force at rupture of the carcass and sidewall reinforcing reinforcements obtained with respect to the tyre T of the prior art.

The drop D of force at rupture at the shoulder, namely the ratio (Fi-Fr)/Fi was also measured for each tyre.

TABLE 3

| T | | 10₁ | | 10₈ | |
|---|---|---|---|---|---|
| | Sidewall | | Sidewall | | Sidewall |
| Carcass | reinforcer | Carcass | reinforcer | Carcass | reinforcer |

| | | | |
|---|---|---|---|
| R | 1 | 1.41 | 1.02 |
| Mass | 100 | 100 | 99 |
| Fi | 100 | 106 | 119 |
| Fr | 100 | 104 | 116 |
| D | −7% | −8.7% | −9.7% |

It will be noted that the tyres 10₁ and 10₈ according to the invention have masses substantially equal to that of the tyre T of the prior art but have a force at rupture, namely a resistance to “pinch shock” that is improved, even after a great many kilometres have been covered.

It will also be noted that although it exhibits a drop that is greater than that of the tyre 10₁, the tyre 10₈ has a residual force at rupture Fr that is higher than that of the tyre 10₁. Specifically, the initial force at rupture Fi of the tyre 10₈ is far higher than that of the tyre 10₁. The tyres 10₁ and 10₈ according to the invention therefore exhibit improved endurance by comparison with the tyre T of the prior art, especially the tyre 10₈.

The invention is not restricted to the embodiments described hereinabove.

Specifically, it is also conceivable to have a tyre according to the invention in which the crown reinforcement also comprises a protective reinforcement interposed radially between the hoop reinforcement and the working reinforcement.

It is also conceivable to have a tyre according to the invention in which the crown reinforcement does not comprise a hoop reinforcement but a protective reinforcement and a working reinforcement, the protective reinforcement being interposed radially between the tread and the working reinforcement.

It could also be conceivable to have an embodiment in which the tyre comprises an airtight inner liner, the airtight inner liner being at least partially covered with a layer of self-sealing product. The advantages listed hereinabove relating to the carcass reinforcing and sidewall reinforcing elements remain and are combined synergistically with those of the layer of self-sealing product to obtain a tyre which is more robust with regard to punctures, whether by having endurance that is optimized with regard to “pinch shock” or the fact that it is resistant to the damaging effects of a puncture.

The features of the various embodiments which have been described or envisaged hereinabove can also be combined provided that they are mutually compatible.

Thus, it is possible to conceive of combining the features of the carcass filamentary reinforcing elements and sidewall reinforcer reinforcing elements of the fifth, sixth, seventh and eighth embodiments with the tyre designs of the second, third and ninth embodiments.

1.-10. (canceled)

11. A tire comprising:
a crown surmounted by a tread,
two sidewalls,
two beads, each sidewall connecting each bead to the crown,
a carcass reinforcement anchored in each of the beads and extending from each bead through each sidewall and comprising textile filamentary carcass reinforcing elements, each textile filamentary carcass reinforcing element comprising at least two carcass multifilament textile plied strands wound in a helix one about the other with a twist R1 expressed in turns per meter,
a sidewall reinforcing reinforcement comprising textile filamentary sidewall reinforcer reinforcing elements, each textile filamentary sidewall reinforcer reinforcing element comprising at least two sidewall reinforcer multifilament textile plied strands wound in a helix one around the other with a twist R2 expressed in turns per meter,
wherein R=max(K1,i)/min(K2,j)>1,
where K1,i is the twist factor of each of the i carcass multifilament textile plied strands of each textile filamentary carcass reinforcing element defined by K1,i=R1·[T1,i/(1000·d1,i)]^{1/2} in which T1,i, expressed in tex, is the count of each of the i carcass multifilament textile plied strands and d1,i is the density of the material in which each of the i carcass multifilament textile plied strands is made, and
where K2,j is the twist factor of each of the j sidewall reinforcer multifilament textile plied strands of each textile filamentary sidewall reinforcer reinforcing element defined by K2,j=R2·[T2,j/(1000·d2,j)]^{1/2} in which T2,j, expressed in tex, is the count of each of the j sidewall reinforcer multifilament textile plied strands and d2,j is the density of the material in which each of the j sidewall reinforcer multifilament textile plied strands is made.

12. The tire according to claim 11, wherein R≧1.05.

13. The tire according to claim 11, wherein R≧1.10.

14. The tire according to claim 11, wherein R≧1.30.

15. The tire according to claim 11, wherein R≧1.40.

16. The tire according to claim 11, wherein R≦2.

17. The tire according to claim 11, wherein R≦1.75.

18. The tire according to claim 11, wherein R≦1.6.

19. The tire according to claim 11, wherein the carcass reinforcement is axially discontinuous, the discontinuity extending axially at least partially under the crown.

20. The tire according to claim 11, wherein the carcass reinforcement comprises a single carcass ply.

21. The tire according to claim 11, wherein the sidewall reinforcing reinforcement comprises a single sidewall reinforcing ply.

22. The tire according to claim 11, wherein the carcass reinforcement is anchored in each bead by being turned up around an annular structure of the bead so as to form a main strand and a turn up.

23. The tire according to claim 11 further comprising a crown reinforcement radially interposed between the carcass reinforcement and the tread.

24. The tire according to claim 23, wherein the crown reinforcement comprises at least one crown ply, and the radially outer end of the sidewall reinforcing reinforcement is axially on the inside of the axially outer end of the crown ply radially adjacent to the sidewall reinforcing reinforcement.

25. The tire according to claim 24, wherein the axial distance between the radially outer end of the sidewall reinforcing reinforcement and the axially outer end of the crown ply radially adjacent to the sidewall reinforcing reinforcement is greater than or equal to 10 mm.
